(19) United States
(12) Patent Application Publication
(10) Pub. No.: US 2020/0327182 A1
(43) Pub. Date: Oct. 15, 2020

(54) METHOD FOR PROCESSING NUMERICAL DATA, DEVICE, AND COMPUTER READABLE STORAGE MEDIUM

(71) Applicant: SZ DJI TECHNOLOGY CO., LTD., Shenzhen (CN)

(72) Inventors: Sijin LI, Shenzhen (CN); Kang YANG, Shenzhen (CN); Yao ZHAO, Shenzhen (CN)

(21) Appl. No.: 16/914,806

(22) Filed: Jun. 29, 2020

Related U.S. Application Data
(63) Continuation of application No. PCT/CN2017/120191, filed on Dec. 29, 2017.

(51) Int. Cl. G06F 17/11; G06N 3/04

(52) U.S. Cl. CPC G06F 17/11; G06N 3/04

(57) ABSTRACT

A method of processing numerical data via a processing device is disclosed. The processing device includes a memory and a processor coupled to the memory, and the method includes identifying, via the processor, a highest non-zero bit of first numerical data, the first numerical data being of a first bit count, identifying, via the processor, a second-highest non-zero bit of the first numerical data, and generating, via the processor, a numerical representation of the first numerical data according to the highest non-zero bit and the second-highest non-zero bit. The numerical representation is of a second bit count smaller than the first bit count of the first numerical data.

### CROSS-REFERENCE TO RELATED APPLICATION

This application is a continuation of International Application No. PCT/CN2017/120191, filed on Dec. 29, 2017, the entire content of which is incorporated herein by reference.

### TECHNICAL FIELD

The present disclosure relates to a technical field of data processing, and in particular to method, device, and computer readable storage medium for numerical data processing.

### BACKGROUND

As one of the most important research and development areas in the artificial intelligence technologies, neural networks have made great progress in recent years. Current mainstream neural network computing framework platforms often use floating-point numbers in training data. Therefore, weight coefficients and various output values of the convolutional and fully connected layers in the neural network are expressed in floating-point numbers. However, compared to operations based on fixed-point numbers, operations based on floating-point numbers are more complex in logics, consume more hardware resources, and require more power. But even with fixed-point numbers, in accelerators involving convolutional neural networks, operations based on fixed-point numbers still require a large amount of multiplication calculations to ensure the real-time nature of the operations. This increases consumed hardware area on one hand, and on the other hand, however, may also increase bandwidth consumption. Therefore, it is much needed to reduce the physical hardware area and power consumption of the convolutional neural network accelerators.

### SUMMARY

One aspect of the present disclosure provides a method of processing numerical data via a processing device. The processing device includes a memory and a processor coupled to the memory, and the method includes identifying, via the processor, a highest non-zero bit of first numerical data, the first numerical data being of a first bit count, identifying, via the processor, a second-highest non-zero bit of the first numerical data, and generating, via the processor, a numerical representation of the first numerical data according to the highest non-zero bit and the second-highest non-zero bit. The numerical representation is of a second bit count smaller than the first bit count of the first numerical data.

Another aspect of the present disclosure provides a device of processing numerical data, the device including a memory and a processor coupled to the memory. The processor is configured to perform identifying a highest non-zero bit of first numerical data, the first numerical data being of a first bit count, identifying a second-highest non-zero bit of the first numerical data, and generating a numerical representation of the first numerical data according to the highest non-zero bit and the second-highest non-zero bit. The numerical representation is of a second bit count smaller than the first bit count of the first numerical data

Another aspect of the present disclosure provides a non-transitory computer-readable storage medium storing computer program instructions executable by a processor to perform identifying a highest non-zero bit of first numerical data, the first numerical data being of a first bit count, identifying a second-highest non-zero bit of the first numerical data, and generating a numerical representation of the first numerical data according to the highest non-zero bit and the second-highest non-zero bit. The numerical representation is of a second bit count smaller than the first bit count of the first numerical data.

### BRIEF DESCRIPTION OF THE DRAWINGS

For a more complete understanding of the embodiments of the present disclosure and associated advantages, reference will now be made to the following description in conjunction with the accompanying drawings.

FIG. 1 is a schematic diagram of a data processing method according to one embodiment of the present disclosure.

FIG. 2 is a schematic flow chart diagram of a data processing method according to another embodiment of the present disclosure.

FIG. 3 is a schematic diagram of a hardware arrangement according to yet another embodiment of the present disclosure.

The drawings are not necessarily drawn to scale but are shown in a schematic manner without compromising readers' understanding.

### DETAILED DESCRIPTION OF THE EMBODIMENTS

In view of the descriptions to follow regarding embodiments of the present disclosure in conjunction with the accompanying drawings, aspects, advantages, and prominent features of the present disclosure will become readily apparent to those skilled in the art.

According to the present disclosure, terms “including” and “containing”, and their derivatives are meant to include, but not limit.

Various embodiments described below are merely illustrative and should not be construed as limiting the scope of the disclosure in any particular way. The following description with reference to the accompanying drawings is to assist in a comprehensive understanding of exemplary embodiments of the present disclosure as defined by the claims and their equivalents. The following description includes a variety of specific details; but these details should be considered as exemplary and illustrative only. Accordingly, those of ordinary skill in the art should recognize that various changes and modifications may be made to the embodiments described herein without having to deviate from the scope and spirit of the present disclosure. Descriptions of well-known functions and constructions are omitted for clarity and brevity. In addition, the same reference numerals are used for the same or similar functions and operations throughout the drawings. In addition, although schemes with different features may be described in different embodiments, those skilled in the art should realize that all or part of the features of different embodiments may be combined to form an embodiment without departing from the spirit and scope of the present disclosure.

Although the following embodiments are described in detail in the context of a convolutional neural network, the present disclosure is not limited thereto. In fact, when scenarios are involved that require numerical representation, the solution according to the embodiment(s) of the present disclosure may be used to reduce data storage demand and to increase operational speed, among others. Although the following embodiments are mainly described based on binary representations, the solutions according to the embodiments of the present disclosure may also be applied to other representations, such as ternary, octal, decimal, and hexadecimal representations, among others. Although the following embodiments are mainly described based on integers, the embodiments of the present disclosure may also be applicable to decimals, among others.

Prior to a description of various embodiments of the present disclosure, below is a description of certain terms and terminologies that may be relevant to the present disclosure.

In the field of machine learning, a convolutional neural network (referred to as CNN or ConvNet) is a type of deep feedforward artificial neural network, which may be used in fields such as image recognition. CNN often includes multiple layers, which include one or more convolutional layers and pooling layers.

A convolutional layer usually uses a small convolution kernel to perform a local convolution operation on input data (for example, an input image) to obtain a feature map as an output to the next layer. The convolution kernel may be a globally shared or non-shared convolution kernel, so that parameters of the corresponding convolution layer, upon training, may obtain values corresponding to the features to be recognized by the layer. For example, in the field of image recognition, the convolution kernel of a front convolutional layer, which is the convolutional layer closer to the original input image, may be used to identify smaller features in the image, such as eyes and noses. The convolution kernel of a back convolutional layer, which is a convolutional layer closer to a final output result, may be used to identify larger features in the image such as human faces, so as to obtain recognition results as to whether an image contains a human face.

Under the conditions of zero padding, stride being 1, and no bias, exemplary convolution calculation results may be shown in Equation (1),

$$[ \begin{matrix}1 & 1 & 1 & 0 \\ 0 & 1 & 0 & 1 \\ 0 & 0 & 1 & 1 \\ 0 & 0 & 0 & 0\end{matrix} ] ⊗ [ \begin{matrix}0 & 1 \\ 1 & 0\end{matrix} ] = [ \begin{matrix}1 & 2 & 0 \\ 1 & 0 & 2 \\ 0 & 1 & 1\end{matrix} ] \qquad ( 1 )$$

where a first term on the left side of the equation is 4×4 2-dimensional input data, a second term is a 2×2 convolution kernel, the right side of the equation is output data, and ⊗ is the convolution operator. Taking as example an operation of the upper left 2×2 portion

$$[ \begin{matrix}1 & 1 \\ 0 & 1\end{matrix} ]$$

and the convolution kernel in the expression of

$$[ \begin{matrix}0 & 1 \\ 1 & 0\end{matrix} ] : [ \begin{matrix}1 & 1 \\ 0 & 1\end{matrix} ] ⊗ [ \begin{matrix}0 & 1 \\ 1 & 0\end{matrix} ] = 1 \times 0 + 1 \times 1 + 0 \times 1 + 1 \times 0 = 1 ,$$

the upper left portion of the output data

$$[ \begin{matrix}\underline{1} & 2 & 0 \\ 1 & 0 & 2 \\ 0 & 1 & 1\end{matrix} ]$$

is 1. Similar convolution calculation operations are performed on each of the 2×2 portions of the input data to obtain each of values in

$$[ \begin{matrix}1 & 2 & 0 \\ 1 & 0 & 2 \\ 0 & 1 & 1\end{matrix} ] .$$

It should be noted that this exemplary convolution calculation is only used to illustrate certain convolution calculations in convolutional neural networks, and is not to limit the scope to which the embodiments of the present disclosure are applicable.

The pooling layer is usually a layer used to simplify the input data to the previous layer, where maximum values or average values of data in certain portions of the previous layer are used as replacement to all the data of the certain portions, to reduce amount of calculations in the subsequent layers. In addition, and via streamlining the data, overfitting may be effectively avoided to reduce possibility of incorrect learning results.

Moreover, convolutional neural network may include additional layers such as fully connected layers and activation layers. Number calculations associated with these layers do not significantly differ from the above-mentioned convolution layers and pooling layers. Persons in the relevant technical fields may realize these additional layers described herein according to embodiments of the present disclosure, and these details are not described here for brevity.

Fixed-point number or fixed-point number representation is a type of real data commonly used in computer data processing, which has a fixed number of bits after the radix point, for example, the decimal point “.” in decimal representation. Compared with floating-point representation, representation with fixed-point numbers are relatively fixed, so they may perform arithmetic operations faster and occupy less memory when storing data. In addition, because some processors do not have floating-point number calculation functions, fixed-point numbers are more compatible than floating-point numbers. Common fixed-point number representations include, for example, decimal representation and binary representation, among others. With decimal fixed-point representation, number 1.23 may be presented as 1230 with a scaling factor of 1/1000, and number 1230000 may be presented as 1230 with a scaling factor of 1000. In addition, common binary fixed-point representation may be in the form of “s:m:f” where s represents a number of sign bits, and m represents a number of integer bits. For example, to follow the form of “1:3:4,” number 3 may be presented as “00110000.”

For calculations involving deep convolutional neural network inference, most of the calculations are directed to calculations of the convolution, which involve a great amount of addition and multiplication calculations as described herein elsewhere. There are a variety of ways to optimize convolution calculations, including but not limited to the following. For example, a floating-point number may be converted to a fixed-point number, to reduce power consumption and to decrease bandwidth. For example, numbers may be converted from real numbers to frequency domain to reduce amount of calculations. For example, numbers may be converted from real numbers to logarithmic domain so as to transit from multiplication calculations to addition calculations.

Numerical data is converted to logarithmic domain, or numerical data x is converted to be of the form of 2ⁿ. In practice, the position corresponding to the left most non-zero bit, or the highest non-zero bit, of the binary numerical data may be set as the exponential bit. In disregard of rounding, the binary fixed-point numerical data 1010010000000 may be converted to its approximation 2¹², where only the number 12 is to be stored in actual storage considerations. When sign bits are in consideration, a 5-bit representation may be enough in the bit-width considerations. In comparison to the initial 16-bit, a decrease of 5/16 in bit-width is now realized.

However, in the process of converting a number from a real number domain to the logarithmic domain, the low-level effective information will be completely removed, that is, a certain accuracy may not be retained. What is reflected in the actual practice is that accuracy reduction associated with the convolutional neural network expressed in the logarithmic domain is more significant that of the original floating-point convolutional neural network.

Therefore, in order to at least partially solve or alleviate the above-identified problems, and according to certain embodiments of the present disclosure, a method, a device, and a computer storage medium for processing numerical data are proposed, which are believed to improve on issues associated with relatively low network accuracy in the logarithmic domain, while still maintaining benefits in not necessarily needing multiplication calculations.

Below is a description of solutions in numerical data processing according to embodiment(s) of the present disclosure.

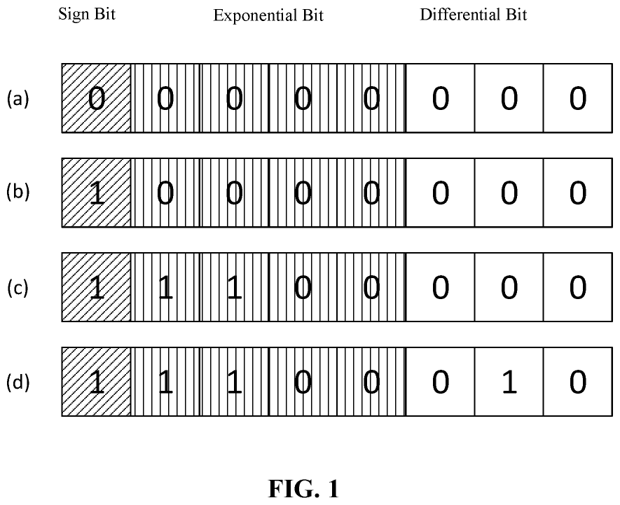

FIG. 1 illustratively depicts data processing flow chart diagram of a data processing method according to embodiment(s) of the present disclosure. As illustratively depicted in FIG. 1, and when the initial numerical data in the form of the 16-bit fixed-point numerical data is employed to represent various parameter data such as convolutional neural network, accuracy lost due to impact of the initial numerical data on the neural network may essentially be neglected or diminished. The fixed-point number of the initial numerical data x to be converted (in this example, x=5248, but the embodiment of the present disclosure is not limited to this) is expressed as

| | Position | | | | | | | | | | | | | | | |
|---|---|---|---|---|---|---|---|---|---|---|---|---|---|---|---|---|
| | 15 | 14 | 13 | 12 | 11 | 10 | 9 | 8 | 7 | 6 | 5 | 4 | 3 | 2 | 1 | 0 |
| Binary Value | 1 | 0 | 0 | 1 | 0 | 1 | 0 | 0 | 1 | 0 | 0 | 0 | 0 | 0 | 0 | 0 |

The highest position or the most left position is the sign bit, the remaining is the integer bit, and the width after conversion to the logarithmic domain is an 8-bit width. For example, and as illustratively depicted in FIG. 1(a) to FIG. 1(d)¹, the highest or the left most position is the sign bit, the next 4 positions are of the exponential bits, and the lowest or the right most 3 positions are of the differential bits. More details are provided in the below descriptions in view of FIG. 1. ¹Revised over the CN version.

As illustratively depicted in FIG. 1(a), an initial representation of the to-be-outputted numerical data \tilde{x} is set at \tilde{x}=00000000. Then sign bit is extracted from the above-mentioned 16-bit fixed-point numerical data representing x; and the sign bit is imported into \tilde{x}, to arrive at 10000000 as illustratively depicted in FIG. 1(b). The first non-zero position, or the highest non-zero position, counting from the highest to the lowest position of the 16-bit fixed-point numerical data, is determined. This step is equivalent to extracting the integer portion via log 2 algorithm. In this embodiment, it is the 12^{th} position of x. As illustratively depicted in FIG. 1C, \tilde{x} is 11100000, where the exponential bit is 1100, corresponding to number 12. Accordingly, the 4-bit exponential part may represent any of the highest position of the 16-bit fixed-position numerical data (or the 15-bit fixed-position numerical data when the sign bit is excluded).

Next, in the direction of the highest to the lowest position, the second-highest non-zero position, and to determine the position differential between the highest non-zero position and the second-highest non-zero position. In an 8-bit representation, which includes the sign bits and the exponential bits, there are 3 bits remaining for the differential bits. With the differential bits being 3 bits, the position differential is no greater than 7. In some embodiments, when the position differential is calculated to be greater than 7, value 7 is used instead. In the above-mentioned embodiment, the second-highest non-zero position of x is the 10^{th} position; therefore, the position differential is diff=12−10=2. As illustratively depicted in FIG. 1(d), where \tilde{x} is 11100010, the position differential is 010, which corresponds to 2.

Reasons for employing the differential bits include the following. Because the exponential bits that represent the highest non-zero bit of the initial numerical data x is already present in the numerical representation of x, namely \tilde{x}; therefore, employing the second-highest non-zero bit that is closest in position to the highest non-zero bit corresponding to the exponential bits results relatively greater accuracy in comparison to representations employing other non-zero bits. Of course, embodiment(s) of the present disclosure are not limited to this beneficial feature. In certain embodiments, other non-zero bits such as third-highest non-zero bits may be employed. In addition, and when the second-highest non-zero bits are employed, and to best utilize the information associated with the highest non-zero bits already existing, a position differential between the highest non-zero bit and the second-highest non-zero bit may be employed to preserve the information representing the highest non-zero bit. In addition, as will be mentioned below, in the case of using this numerical representation, the use of a multiplier may be avoided, thereby ensuring a desirable operation speed and a relatively simple hardware design.

Accordingly, the initial numerical data x=5248 may be approximated in an 8-bit representation as 11100010, or 5120. Therefore, with the mere loss in accuracy of

$$\frac{5248 - 5120}{5248} \approx 2.4 \% ,$$

8 of the initial 16 bits may be eliminated in the numerical representation, which saves about half of the numerical representation bits.

In addition, and according to certain embodiments of the present disclosure, the source of the transformation may not be limited, that is, the input feature value, weight value, and output feature value may be used, and the order of calculation is also not limited, or no particular limitation is placed on which part to be calculated first. The above-mentioned conversion of the 16-bit numerical data to the 8-bit numerical data is only exemplary. According to certain embodiments of the present disclosure, conversion may be performed on numerical data with bit count greater than 16, and to obtain resultant numerical data with bit count smaller than 8.

Under certain extreme conditions, and when the initial numerical data x is 0, the numerical data \tilde{x} after conversion may be presented in approximation as 11111111.

The above-mentioned numerical data may be sectioned into to three parts. A first part, or the sign bit part, represents a sign of the numerical data. For example, the 7^{th} bit in the above-mentioned example is the sign bit. A second part, covering the exponential bits, represents the highest non-zero position, such as the 3^{rd} to 6^{th} bits of the above-mentioned example. A third part, covering the differential bits, represents a position differential between the highest non-zero position and the second-highest non-zero position, such as the 0^{th} position to the 2^{nd} position of the above-mentioned example.

In some embodiments, sign bits do not necessarily need to be present, such as when there is no sign bit value. In some other embodiments, differential bits do not necessarily need to be present, to be compatible with the fixed-point number representation mentioned herein elsewhere. Moreover, number of bits occupied by each part may change, and is not limited to the above-mentioned 8-bit representation in a 1:4:3 allocation. The number of bits may be of any suitable value, and the three parts may be of any suitable bit allocations.

When the initial numerical representation is subjected to the above-mentioned processing and thereafter presented with, for example, the above-mentioned three parts, realized benefits may include relatively less data storage space needed, and faster addition and multiplication operations, while having a relatively high calculation accuracy maintained.

As will be discussed in detail below, when the numerical data is expressed in the manner described above, numerical calculations, such as the convolution calculations in the above-mentioned convolutional neural network, may still be performed efficiently. In certain embodiments, if the numerical representation of the numerical data x₁ is presented as (sign(x₁), a1, b1), the numerical representation of the numerical data x₂ is presented as (sign(x₂), a2, b2), where sign(x₁) [symbol] sign(x₂) are values respectively representing the sign bits of x₁ and x₂, a1 and a2 are values respectively representing the exponential bits of x₁ and x₂, b1 and b2 are values respectively representing the positional differential bits of x₁ and x₂, the product of x₁ and x₂ may be presented in Equation (5) shown below:

$${x}_{1} \times {x}_{2} \approx sign ( {x}_{1} ) \times sign ( {x}_{2} ) \times ( {2}^{a 1} + {2}^{a 1 - b 1} ) \times ( {2}^{a 2} + {2}^{a 2 - b 2} ) = sign ( {x}_{1} ) \times sign ( {x}_{2} ) \times ( {2}^{a 1 + a 2} + {2}^{a 1 + a 2 - b 2} + {2}^{a 1 - b 1 + a 2} + {2}^{a 1 - b 1 + a 2 - b 2} ) = sign ( {x}_{1} ) \times sign ( {x}_{2} ) \times ( ( 1 ≪ a 1 + a 2 ) + ( 1 ≪ a 1 + a 2 - b 2 ) + ( 1 ≪ a 1 - b 1 + a 2 ) + ( 1 ≪ a 1 - b 1 + a 2 - b 2 ) ) \qquad ( 5 )$$

As may be observed from the Equation (5), since the two multiplication operations sign(x₁)×sign(x₂)×(arbitrary value) may be connected to each other via “or” or “and/or,” multiplication calculations of x₁ and x₂ may employ shift operation via “<<” and addition operation via “+.” This avoids the use of multipliers, which brings more efficiencies to the hardware design, and makes the hardware occupy less area and operate faster.

By employing the above-mentioned representation methods, and in convolutional neural network calculations, for example, accuracy may be substantially increased while the calculation speed is well maintained. Table 1 shows improvement on calculation speed and/or accuracy in several known convolutional neuronal networks according to certain embodiments of the present disclosure.

| Network | Method | Accuracy |
|---|---|---|
| Alexnet | float | 59 |
| | logQuanNoDiff | 53 |
| | logQuanWithDiff | 57 |
| VGG16 | float | 66 |
| | logQuanNoDiff | 57 |
| | logQuanWithDiff | 65 |
| GoogLeNet | float | 66 |
| | logQuanNoDiff | 46 |
| | logQuanWithDiff | 59 |

Float representation is the original floating-point network model, logQuanNoDiff is a method without employing the second-highest bit, or the differential bit, while logQuanWithDiff is a method employing the second-highest bit, or the differential bit. It may be observed from the table shown above, and in comparison to the original methods of using the floating-point network and the method of using the fixed-point network for several popular networks of Alexnet/VGG16/GoogLeNet, adopting the method according to the above-mentioned embodiments of the present disclosure results in a level of accuracy closer to the floating-point network, while delivering calculation speed comparable to the fixed-point representation method.

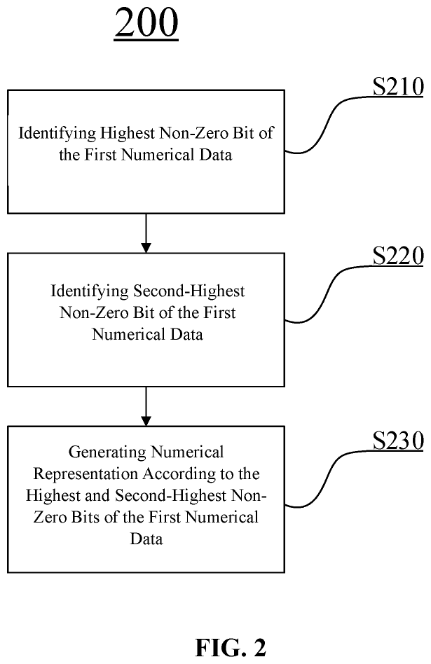

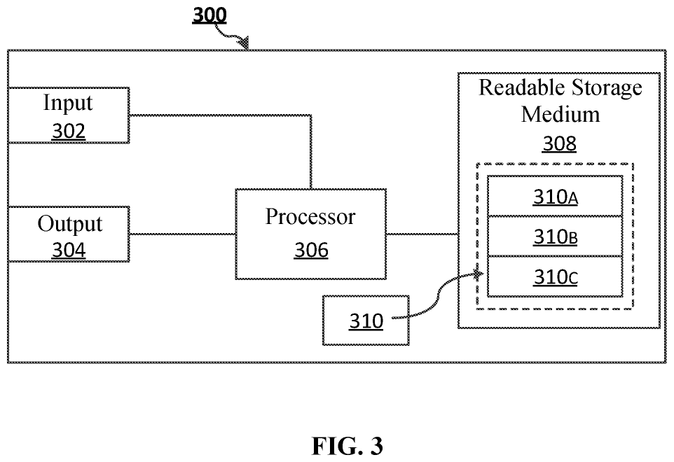

In view of FIG. 1 and FIG. 2, below is a description of a method 200 of processing numerical data to be executed via a hardware arrangement 300 illustratively depicted in FIG. 3 according to embodiment(s) of the present disclosure.

The method 200 starts at step S210, where at the step S210, the highest non-zero bit of the first numerical data is identified or determined via a processor 306 of the hardware arrangement 300.

At step S220, the second-highest non-zero bit of the first numerical data is identified via the processor 306 of the hardware arrangement 300.

At step S230, the processor 306 of the hardware arrangement 300 identifies the numerical representation of the first numerical data according to at least the highest non-zero bit and the second-highest non-zero bit.

In some embodiments, the method 200 further includes: identifying the sign bit of the first numerical data. In addition, the step S230 further includes generating the numerical representation of the first numerical data according to the highest non-zero bit, the second-highest non-zero bit, and the sign bit. In some embodiments, step S230 further includes determining the first sub-representation corresponding to a position of the highest non-zero bit, determining the second sub-representation corresponding to a position differential between the position of the highest non-zero bit and the position of the second-highest non-zero bit, and generating the numerical representation of the first numerical data according to the first and second sub-representations. In some embodiments, generating the numerical representation of the first numerical data according to the first sub-representation and the second sub-representation includes connecting the first sub-representation and the second sub-representation in this order to form the numerical representation of the first numerical data. In some embodiments, generating the numerical representation of the first numerical data according to the highest non-zero bit, the second-highest non-zero bit, and the sign bit includes: determining the first sub-representation corresponding to a position of the highest non-zero bit; determining the second sub-representation corresponding to a position differential between the position of the highest non-zero bit and a position of the second-highest non-zero bit; and generating the numerical representation of the first numerical data according to the first sub-representation, the second sub-representation, and the sign bit.

In certain embodiments, generating the numerical representation at least according to the first sub-representation, the second sub-representation, and the sign bit includes: connecting the third sub-representation corresponding to the sign bit, the first sub-representation, and the second sub-representation to form a sequence representation, and setting the sequence representation as the numerical representation of the first numerical data. In certain embodiments, the sign bit, the highest non-zero bit, and/or the second-highest non-zero bit of the first numerical data may be determined according to binary fixed-point number representation of the first numerical data. In certain embodiments, the method 200 further includes: identifying the highest non-zero bit of the second numerical data; identifying the second-highest non-zero bit of the second numerical data; and generating the numerical representation of the second numerical data at least according to the highest non-zero bit and the second-highest non-zero bit of the second numerical data. In certain embodiments, the method 200 further includes: determining multiplication of the first numerical data and the second numerical data according to the numerical representation of the first numerical data and the numerical representation of the second numerical data. In certain embodiments, determining multiplication of the first numerical data and the second numerical data according to the numerical representation of the first numerical data and the numerical representation of the second numerical data includes:

x₁×x₂≈sign(x₁)×sign(x₂)×((1<<(a1+a2))+(1<<(a1+a2−b2))+(1<<(a1−b1+a2))+(1<<(a1−b1+a2−b2)))

where x₁ represents the first numerical data, x₂ represents the second numerical data, sign(x₁) represents the third sub-representation corresponding to the sign bit of the first numerical data, sign(x₂) represents the third sub-representation corresponding to the sign bit of the second numerical data, a1 represents the first sub-representation of the first numerical data, a2 represents the second sub-representation of the first numerical data, b1 represents the first sub-representation of the second numerical data, b2 represents the second sub-representation of the second numerical data, and sign “<<” represents shift operation.

In certain embodiments, the method 200 further includes: when the first numerical data is 0, the numerical representation of the first numerical data is presented with 1 in each position. In certain embodiments, the method 200 further includes: when or if the second sub-representation of the first numerical data exceeds a preset threshold, the preset threshold is set as the second sub-representation of the first numerical data.

FIG. 3 is a block diagram illustrating an exemplary hardware arrangement 300 according to an embodiment of the present disclosure. The hardware arrangement 300 may include a processor 306, such as a central processing unit (CPU), a digital signal processor (DSP), a microcontroller unit (MCU), a neural network processor/accelerator, among others. The processor 306 may be a single processing unit or multiple processing units for executing different actions of the processes described herein. The hardware arrangement 300 may further include an input unit 302 for receiving signals from other entities, and an output unit 304 for providing signals to other entities. The input unit 302 and the output unit 304 may be arranged as a single entity or separate entities.

Further, the hardware arrangement 300 may include at least one readable storage medium 308 in the form of a non-volatile or volatile memory, such as an electrically erasable programmable read-only memory (EEPROM), a flash memory, and/or a hard drive. The readable storage medium 308 includes computer program instructions 310 which in turn includes code/computer readable instructions that, when executed by the processor 306 in the hardware arrangement 300, cause the hardware arrangement 300 and/or electrical devices included in the hardware arrangement 300 to execute the processes described above in conjunction with FIGS. 1-2 and any variations thereof.

The computer program instructions 310 may be configured as computer program instruction codes having, for example, computer program instruction modules 310A-310C architecture. In certain embodiments where hardware arrangement 300 is employed in the electrical device, codes of the computer program instructions of the hardware arrangement 300 include module 310A employed to determine the highest non-zero position of the first numerical data. The codes of the computer program instructions of the hardware arrangement 300 further include module 310B employed to determine the second-highest non-zero position of the first numerical data. The codes of the computer program instructions of the hardware arrangement 300 further include module 310C employed to determine the numerical representation of the first numerical data according to the highest non-zero position and the second-highest non-zero position.

The computer program instruction module may substantively execute each action in the flow shown in FIGS. 1-2 to simulate a corresponding hardware module. In other words, when different computer program instruction modules are executed in the processor 306, they may correspond to the same and/or different hardware modules in the electronic device.

Although code means closed herein according to embodiments of the present disclosure and in connection with FIG. 3 may be implemented as a computer program instruction module, which, when executed in the processor 306, causes the hardware arrangement 300 to perform the actions described above in connection with FIGS. 1-2. In certain embodiments, at least one of the code means may be implemented at least partially as a hardware circuit.

The processor may be a single CPU (Central Processing Unit), but it may also include two or more processing units. For example, the processor may include a general-purpose microprocessor, an instruction set processor, and/or an associated chipset, and/or a special purpose microprocessor, for example, an application specific integrated circuit (ASIC). The processor may also include on-board memory for caching purposes. Computer program instructions may be carried out by a computer program instruction product connected to a processor. The computer program instruction product may include a computer-readable medium having computer program instructions stored thereon. For example, the computer program instruction product may be a flash memory, a random access memory (RAM), a read-only memory (ROM), and an EEPROM, and the above-mentioned computer program instruction module may be distributed to different computer program instruction products in the form of storage device included in the UE.

It should be noted that functions described in this article as being implemented by pure hardware, pure software and/or firmware may also be implemented via specific hardware, a combination of general hardware and software, and the like. For example, functions described as being implemented through dedicated hardware (for example, Field Programmable Gate Array (FPGA), Application Specific Integrated Circuit (ASIC), and the like) may be processed by general-purpose hardware (for example, Central Processing Unit (CPU), digital signal processing) (DSP)) and software, and vice versa.

Although the present disclosure has been shown and described with reference to specific exemplary embodiments thereof, those skilled in the art will understand that, without departing from the spirit and scope of the present disclosure as defined by the appended claims and their equivalents, various changes in form and detail may be to the present disclosure. Therefore, the scope of the present disclosure should not be limited to the embodiments described above, but should be determined not only by the appended claims, but also by the equivalents of the appended claims.

What is claimed is:

1. A method of processing numerical data via a processing device, the processing device including a memory and a processor coupled to the memory, the method comprising:
identifying, via the processor, a highest non-zero bit of first numerical data, the first numerical data being of a first bit count;
identifying, via the processor, a second-highest non-zero bit of the first numerical data; and
generating, via the processor, a numerical representation of the first numerical data according to the highest non-zero bit and the second-highest non-zero bit, wherein the numerical representation is of a second bit count smaller than the first bit count of the first numerical data.

2. The method of claim 1, further comprising:
identifying a sign bit of the first numerical data, wherein generating the numerical representation of the first numerical data according to the highest non-zero bit and the second-highest non-zero bit includes:
generating the numerical representation of the first numerical data according to the highest non-zero bit, the second-highest non-zero bit, and the sign bit.

3. The method of claim 2, wherein generating the numerical representation of the first numerical data according to the highest non-zero bit, the second-highest non-zero bit, and the sign bit includes:
determining a first sub-representation corresponding to a position of the highest non-zero bit;
determining a second sub-representation corresponding to a position differential between the position of the highest non-zero bit and a position of the second-highest non-zero bit; and
generating the numerical representation of the first numerical data according to the first sub-representation, the second sub-representation, and the sign bit.

4. The method of claim 3, wherein generating the numerical representation of the first numerical data according to the first sub-representation, the second sub-representation, and the sign bit includes:
forming a sequence representation connecting a third sub-representation, the first sub-representation, and the second sub-representation, in this order, the third sub-representation corresponding to the sign bit; and
outputting the sequence representation as the numerical representation of the first numerical data.

5. The method of claim 1, wherein generating the numerical representation of the first numerical data according to the highest non-zero bit and the second-highest non-zero bit includes:
determining a first sub-representation corresponding to a position of the highest non-zero bit;
determining a second sub-representation corresponding to a differential between the position of the highest non-zero bit and a position of the second-highest non-zero bit; and
generating the numerical representation of the first numerical data according to the first sub-representation and the second sub-representation.

6. The method of claim 5, wherein generating the numerical representation of the first numerical data according to the first sub-representation and the second sub-representation includes:
forming a sequence representation connecting the first sub-representation and the second sub-representation, in this order; and
outputting the sequence representation as the numerical representation of the first numerical data.

7. The method of claim 3, further comprising:
when the first numerical data is 0, designating each position of the numerical representation of the first numerical data as 1.

8. The method of claim 3, further comprising:
when the second sub-representation of the first numerical data is greater than a preset threshold, setting the preset threshold as the second sub-representation of the first numerical data.

9. The method of claim 1, wherein at least one of identifying the sign bit, identifying the highest non-zero bit, or identifying the second-highest non-zero bit of the first numerical data is carried out via binary fixed-point representation of the first numerical data.

10. The method of claim 1, further comprising:
identifying a highest non-zero bit of a second numerical data;
identifying a second-highest non-zero bit of the second numerical data;
generating a numerical representation of the second numerical data according to the highest non-zero bit and the second-highest non-zero bit of the second numerical data; and
determining a product of the first and second numerical data according to the numerical representation of the first numerical data and the numerical representation of the second numerical data.

11. The method of claim 10, wherein determining the product of the first and second numerical data according to the numerical representation of the first numerical data and the numerical representation of the second numerical data includes:
solving equation
x₁×x₂≈sign(x₁)×sign(x₂)×((1<<(a1+a2))+(1<<(a1+a2−b2))+(1<<(a1−b1+a2))+(1<<(a1−b1+a2−b2)))
wherein x₁ represents the first numerical data, x₂ represents the second numerical data, sign(x₁) represents the third sub-representation corresponding to the sign bit of the first numerical data, sign(x₂) represents the third sub-representation corresponding to the sign bit of the second numerical data, a1 represents the first sub-representation of the first numerical data, a2 represents the second sub-representation of the first numerical data, b1 represents the first sub-representation of the second numerical data, b2 represents the second sub-representation of the second numerical data, and sign “<<” represents shift operation.

12. A device of processing numerical data, comprising a memory and a processor coupled to the memory, the processor being configured to perform:
identifying a highest non-zero bit of first numerical data, the first numerical data being of a first bit count;
identifying a second-highest non-zero bit of the first numerical data; and
generating a numerical representation of the first numerical data according to the highest non-zero bit and the second-highest non-zero bit, wherein the numerical representation is of a second bit count smaller than the first bit count of the first numerical data.

13. The device of claim 12, wherein the processor is further configured to perform:
identifying a sign bit of the first numerical data; and
generating the numerical representation of the first numerical data according to the highest non-zero bit, the second-highest non-zero bit, and the sign bit.

14. The device of claim 12, wherein the processor is further configured to perform:
determining a first sub-representation corresponding to a position of the highest non-zero bit;
determining a second sub-representation corresponding to a position differential between the position of the highest non-zero bit and a position of the second-highest non-zero bit; and
generating the numerical representation of the first numerical data according to the first sub-representation, the second sub-representation, and the sign bit.

15. The device of claim 14, wherein the processor is further configured to perform:
forming a sequence representation connecting the first sub-representation and the second sub-representation, in this order; and
outputting the sequence representation as the numerical representation of the first numerical data.

16. The device of claim 13, wherein the processor is further configured to perform:
determining a first sub-representation corresponding to a position of the highest non-zero bit;
determining a second sub-representation corresponding to a position differential between the position of the highest non-zero bit and a position of the second-highest non-zero bit; and
generating the numerical representation of the first numerical data according to the first sub-representation, the second sub-representation, and the sign bit.

17. The device of claim 16, wherein the processor is further configured to perform:
forming a sequence representation connecting a third sub-representation, the first sub-representation, and the second sub-representation, in this order, the third sub-representation corresponding to the sign bit; and
outputting the sequence representation as the numerical representation of the first numerical data.

18. The device of claim 12, wherein at least one of identifying the sign bit, identifying the highest non-zero bit, or identifying the second-highest non-zero bit of the first numerical data is carried out via binary fixed-point numbering of the first numerical data.

19. The device of claim 12, wherein the processor is further configured to perform:
identifying a highest non-zero bit of a second numerical data;
identifying a second-highest non-zero bit of the second numerical data;
generating a numerical representation of the second numerical data according to the highest non-zero bit and the second-highest non-zero bit of the second numerical data; and
determining a product of the first and second numerical data according to the numerical representation of the first numerical data and the numerical representation of the second numerical data.

20. A non-transitory computer-readable storage medium storing computer program instructions executable by a processor to perform:
identifying a highest non-zero bit of first numerical data, the first numerical data being of a first bit count;
identifying a second-highest non-zero bit of the first numerical data; and
generating a numerical representation of the first numerical data according to the highest non-zero bit and the second-highest non-zero bit, wherein the numerical representation is of a second bit count smaller than the first bit count of the first numerical data.
